(19) United States
(12) Patent Application Publication
(10) Pub. No.: US 2025/0191098 A1
(43) Pub. Date: Jun. 12, 2025

(54) COMPUTER-IMPLEMENTED SYSTEM AND METHOD FOR PROVIDING EMERGENCY ALERTS

(71) Applicant: Andrew KAHLER, Geham (AU)

(72) Inventor: Andrew KAHLER, Geham (AU)

(21) Appl. No.: 18/846,287

(22) PCT Filed: Mar. 20, 2023
(86) PCT No.: PCT/AU2023/050193

§ 371 Date: Sep. 12, 2024

(30) Foreign Application Priority Data
Mar. 18, 2022 (AU) 2022900665

(51) Int. Cl. G06Q 50/26; G08B 21/02; G08B 25/01; G08B 25/10; H04W 4/021; H04W 4/029; H04W 4/90

(52) U.S. Cl. CPC G06Q 50/265; G08B 21/02; G08B 25/016; G08B 25/10; H04W 4/021; H04W 4/029; H04W 4/90

(57) ABSTRACT

A computer implemented method for alerting and displaying to users the existence of a potential emergency/hazard at location of interest, and enabling the real-time granting of permits to users seeking to engage in activities within or near the particular location. The invention is performed through an application that a user accesses to request information of a particular area or a permit for an activity. In processing these requests, the system refers to a database which stores information about these hazards or potential hazards.

### FIELD OF THE INVENTION

The present invention relates to a computer implemented system and method of alerting individuals regarding the existence of an actual or potential emergency or hazard (e.g. bushfire) in a particular geographical area or location of interest, and enabling the real-time granting of permits to individuals seeking to engage in particular activities based upon the particular geographical area or location. The system and method further enables authorities to quickly and efficiently determine whether a particular activity recorded at a geographical area or location is a permitted activity.

### BACKGROUND OF THE INVENTION

Recreational activities such as camping, bushwalking and hiking are very popular but often require individuals to travel to remote or rural locations. The nature of such locations and the activities that occur in these locations typically give rise to an increase in emergency situations (e.g. due to characteristics of the particular location, or the propensity for hazards such as bushfires, floods, severe storms, earthquakes, and the like). For example, individuals will typically start a campfire at a campsite, but if a campfire is left unattended or is unable to be controlled, a bush or grass fire may ensue and cause significant damage, injury or even loss of life. For this reason, there are certain locations or regions where activities such as starting a fire are prohibited or restricted by relevant governing authorities, such as a State or Federal Government or local council. The same applies to other activities, such as hiking for example, where terrain at a particular location is deemed to be too dangerous and as a result, hiking is prohibited. In another example, there may be a beach location where swimming is prohibited or restricted during certain months due to hazardous waters.

There may be additional reasons regarding why certain activities should not occur at particular locations including due to the recordal of an actual (current) or potential (future) hazard at the location. In this regard, even if the location has no official prohibition or restriction assigned to it, an actual hazard occurring in the area, or a potential hazard that is likely to occur, may still pose a risk to individuals in, or travelling to, the area. For example, there may be a fire, flood, severe storm, fallen power line, earthquake or other emergency occurring, or predicted to occur, at the particular location.

A problem occurs when individuals seek to camp, hike, swim, or engage in some other recreational activity in a particular geographical area or location of interest, where the individuals may not be aware of the official prohibition or restriction regarding activities or any additional emergencies that may be active or expected to occur in the particular area or location. This can result in disappointment upon arrival at the location once the individual becomes aware of the prohibition, restriction or emergency, but more importantly, may cause individuals to elect to engage in the activities irrespective of potential consequences, thereby placing their own lives as well as the lives of others at risk. For example, individuals who have gone to the effort of travelling to a particular location may, upon arrival, choose to disregard official restrictions, or may engage in activities without understanding or realizing that there is a hazard that is occurring, or is about to occur, at the location.

Another problem arises when authorities seek to manage emergencies or potential emergencies, including whether activities recorded at a particular location are permitted or not and hence whether the activities are likely to give rise to an emergency situation. For example, in the case of an activity that has been recorded by an authority (e.g. based upon a call initiated by a third party witnessing another individual engaging in the activity at the particular location), it is often difficult for the authority to determine whether the activity recorded is a permitted activity (and hence unlikely to represent a potential emergency after all). Authorities often dispatch emergency vehicles and personnel to locations at which particular activities have been recorded out of an abundance of caution, but this can be a waste of time and resources since the activity recorded may well be a permitted activity for that particular geographical area or location.

In another example, where the authority records an actual or potential hazard, or records an activity that is likely to give rise to a hazard, there are challenges that exist with respect to notifying (and generally communicating) with individuals at the particular location, or preventing the movement of individuals to the location. By the time individuals are notified, or by the time authorities arrive at the particular location, it can often be too late since significant damage, injury, and even loss of life may already have occurred, or the hazard may have evolved to become even less manageable.

Accordingly, there exists a need for a system and method that addresses, or at least ameliorates, some of the abovementioned problems.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method for generating emergency alerts, the method including, receiving, by one or more processors, a request from a user device for information relating to a particular geographical area or location of interest, retrieving, by one or more processors, from a database containing information regarding recorded hazards or potential hazards in a plurality of different geographical regions or locations, information pertaining to any hazards or potential hazards recorded at the particular geographical area or location of interest, based upon the existence of a recorded hazard or potential hazard at the particular geographical area or location of interest, and in response to the user request, causing the user device to display geo-fenced zones within, or in proximity to, the geographical area or location of interest detailing any zones which are affected by the recorded hazard or potential hazard, based upon there being no recorded hazards or potential hazards at the particular geographical area or location of interest, causing, by one or more processors, the user device to prompt the user to select one or more activities occurring, or likely to occur, and in which the user is, or likely to be, engaged, in the geographical area or location of interest, retrieving, by one or more processors, from a database containing information related to prohibitions or restrictions relevant to the particular geographical area or location of interest, information pertaining to activities requiring a permit as a result of any prohibitions or restrictions, and based upon the one or more activities requiring a permit, automatically issuing, by one or more processors, an electronic permit to the user device for any permitted activities that authorises the user to engage in the one or more activities in the geographical location or area of interest

In the example scenario of an individual seeking to camp in a particular geographical area or location and preferring to establish a campfire, a user may quickly and efficiently, via their device and prior to travelling to the location, not only determine whether there are any (or likely to be any) emergency situations or hazards (such as bushfires, floods, severe storms, etc) but also receive, in the event that their proposed activities at the particular geographical area or location (eg. starting a campfire) are prohibited or restricted without a permit, obtain a permit authorizing them to conduct the activities.

Since information relating to the occurrence of hazards and the issuance of permits is recorded through the use of a computer-implemented platform, and since a software application operating on the user device provides a substantially real-time communication gateway to individuals engaged in such activities, the management of emergency situations by relevant authorities is also more efficient. For example, the relevant authority can quickly and efficiently communicate with relevant individual(s) to prevent the individual(s) from travelling to the particular geographical area or location, or to request that individual(s) already in the area cease movement or evacuate, if required.

In an embodiment, the method further includes storing, by one or more processors, data relating to the activities selected by a plurality of different users in a plurality of different geographical locations or areas, and data relating to permits issued in respect of the activities, receiving, by one or more processors, a request from an authority responsible for managing emergency situations to access a report regarding a particular geographical location or area, and providing, by one or more processors, in response to the request from the authority responsible for managing emergency situations a report regarding activities recorded and any permits issued in respect of the particular geographical area or location.

Accordingly, the relevant authority also has the ability to consult a database to determine whether activities recorded as being conducted in a particular area or location (eg. from a third party located at the same campsite) represent authorized activities, (ie. activities for which a permit has been issued). This conserves considerable time, effort and resources on the part of the authority who would otherwise be required to dispatch emergency personnel and vehicles to the particular location.

In an embodiment, a central server is operable to communicate with the user device as well as any devices operated by the authority responsible for managing emergency situations, and each device is operable to execute a software application that enables communication with the central server.

In one example, the prohibition or restriction that exists at the particular geographical area or location of interest arises from the particular geographical area or location being in a restricted fire zone, and the one or more activities requiring a permit includes igniting a fire.

In an embodiment, the authority responsible for managing emergency situations includes one or more of a fire department, a police department, a hospital, and one or more individuals employed by the authority.

In an embodiment, when a hazard or potential hazard is recorded at the particular geographical area or location of interest, or associated geo-fenced zone, the method further includes, causing, by one or more processors, the user device to alert the user to the hazard or potential hazard including providing the user with one or more notifications issued by an authority responsible for managing emergency situations.

In an embodiment, when the particular geographical area or location of interest, and geo-fenced zones within or in proximity thereto, are displayed to the user and one or more are affected by the recorded hazard or potential hazard, the method further includes, causing, by one or more processors, the user device to prompt the user to select the area or location of interest or geo-fenced zone designated on the display of the user device as an area of an actual or potential hazard, to access further details regarding the hazard or potential hazard including links to one or more authorities responsible for managing emergency situations and enabling a live data exchange between the authority and the user.

In an embodiment, the electronic permit issued to the user is created based on location and category, such that different permits will issue in respect of different locations and/or different categories of activities including activity sub-categories. For example, in the case of a permit authorising the individual to ignite a fire, the permit category may be fire and the sub-category may specify the type of fire, e.g. a small campfire, picnic fire, or hazard reduction burning.

In an embodiment, issuing an electronic permit to the user device further includes, providing, to the user device upon issuance of the electronic permit, or at a particular time thereafter, a checklist of safety measures in relation to the one or more activities. For example, where the activity is igniting a fire, the checklist may provide one or more of safety instructions for igniting the fire, extinguishing the fire, and instructions for vacating the location and leaving the location in a suitable and safe condition.

In an embodiment, the method further includes causing, by one or more processors, the user device to prompt the user to submit a completed checklist, and receiving, by one or more processors, the completed checklist and automatically transmitting same to a relevant authority responsible for managing emergency situations in the geographical are or location.

In an embodiment, the method further includes detecting, by one or more processors, that the completed check-list has not been received within a pre-defined time period of the user vacating the geographical area or location, and automatically transmitting, by one or more processors, a notification regarding the non-completion of the checklist by the user to the relevant authority responsible for managing emergency situations in the geographical area or location. In an example, detecting that a user has vacated a geographical area or location is achieved by monitoring a location of the user device using one or more of GPS, Wi-Fi, Cell ID or A-GPS monitoring.

In an embodiment, the method further includes causing, by one or more processors, devices associated with relevant authorities responsible for managing emergency situations in particular geographical areas or locations to also display the information pertaining to hazards or potential hazards recorded at the geographical area or location of interest, and geo-fenced zones within, or in proximity to, the geographical area or location detailing any zones which are affected by the recorded hazard or potential hazard.

In an embodiment, the information displayed on devices associated with authorities responsible for managing emergency situations further includes a map and associated information pertaining to permits issued to users in selected geographical areas or locations displayed on the map.

In an embodiment, the information pertaining to permits includes one or more of details of the permit, a category or sub-category of the permit, the user to whom the permit was issued, and the contact details of the user.

In an embodiment, when a user device is determined to be in proximity to a geographical area or location in which an actual, or potential, hazard has been recorded, the method further includes, causing, by one or more processors, the user device to generate one or more alerts or notifications for transmission to the user.

In an embodiment, a related software application may also be made accessible to property owners or their representatives, to enable the property owners to be provided access to information pertaining to hazards or potential hazards in particular geographical areas or locations, wherein said access is sufficient to enable property owners to upload information pertaining to their properties for addressing emergency situations that arise in their proximity.

In an embodiment, the information uploaded by property owners includes information relating to the location and operation of hardware that exists on the property that is configured to prevent or address particular hazards or potential hazards. In the example of a fire hazard, useful information from property owners may relate to their water sources and fire breaks, for example. In this regard, the method may further include sending reminder notifications to user devices associated with the property owners in relation to maintenance of, and access to, their hardware including water sources and fire breaks.

In an embodiment, the method further includes transmitting, by one or more processors, information to the users who are or represent property owners regarding the preparation of their property in the event of a hazard on or in close proximity to their property. The information may include, but is not limited to, gutter cleaning, rubbish removal, grass cutting etc.

In an embodiment, the method further includes receiving and storing information regarding a user's “favourite” geographical area or location of interest and send one or more notifications to the user if an actual or potential hazard is recorded for one or more “favourite” geographical areas or locations of interest.

In an embodiment, the system may employ code masking software.

In a second aspect, the present invention provides a system for generating emergency alerts, the system including one or more processors that receive a request from a user device for information relating to a particular geographical area or location of interest, retrieve, from a database containing information regarding recorded hazards or potential hazards in a plurality of different geographical regions or locations, information pertaining to any hazards or potential hazards recorded at the particular geographical area or location of interest, based upon the existence of a recorded hazard or potential hazard at the particular geographical area or location of interest, and in response to the user request, cause the user device to display geo-fenced zones within, or in proximity to, the geographical area or location of interest detailing any zones which are affected by the recorded hazard or potential hazard, based upon there being no recorded hazards or potential hazards at the particular geographical area or location of interest, cause the user device to prompt the user to select one or more activities occurring, or likely to occur, and in which the user is, or likely to be, engaged, in the geographical area or location of interest, retrieve, from a database containing information related to prohibitions or restrictions relevant to the particular geographical area or location of interest, information pertaining to activities requiring a permit as a result of any prohibitions or restrictions, and based upon the one or more activities requiring a permit, automatically issue an electronic permit to the user device for any permitted activities that authorises the user to engage in the one or more activities in the geographical location or area of interest.

In a third aspect, the present invention provides a computer-readable medium that, when executed on a computer, causes one or more processors of the computer to perform steps to generate emergency alerts, including receiving a request from a user device for information relating to a particular geographical area or location of interest, retrieving, from a database containing information regarding recorded hazards or potential hazards in a plurality of different geographical regions or locations, information pertaining to any hazards or potential hazards recorded at the particular geographical area or location of interest, based upon the existence of a recorded hazard or potential hazard at the particular geographical area or location of interest, and in response to the user request, causing the user device to display geo-fenced zones within, or in proximity to, the geographical area or location of interest detailing any zones which are affected by the recorded hazard or potential hazard, based upon there being no recorded hazards or potential hazards at the particular geographical area or location of interest, causing the user device to prompt the user to select one or more activities occurring, or likely to occur, and in which the user is, or likely to be, engaged, in the geographical area or location of interest, retrieving, from a database containing information related to prohibitions or restrictions relevant to the particular geographical area or location of interest, information pertaining to activities requiring a permit as a result of any prohibitions or restrictions, and based upon the one or more activities requiring a permit, automatically issuing an electronic permit to the user device for any permitted activities that authorises the user to engage in the one or more activities in the geographical location or area of interest.

### BRIEF DESCRIPTION OF THE DRAWINGS

Embodiments of the invention will now be described in further detail with reference to the accompanying Figures in which:

FIG. 1 provides an overview of a system according to an embodiment of the present invention showing, in particular, the interaction between various system components;

FIG. 2 illustrates an exemplary diagram associated with the server component within the system illustrated in FIG. 1;

FIG. 3 illustrates an exemplary flow diagram of a process that enables registered users to download and install a software application, and subsequently access, or register to use, the software application, for interaction with the system illustrated in FIG. 1, including an interface enabling access to one or more databases containing information relating to recorded hazards or potential hazards in different geographical regions or locations;

FIG. 4 illustrates a diagram associated with example interfaces of the software application including an interface for individuals to view results relating to recorded hazards or potential hazards at a particular geographical area or location of interest, and an interface for obtaining an electronic permit to engage in one or more activities;

FIG. 5 illustrates a diagram associated with example interfaces of the software application including an alerts interface and a safety interface;

FIG. 6 illustrates a diagram associated with a further example interface of the software application to provide authorities, property owners, and the like, access to the application functionality;

FIG. 7 illustrates a diagram associated with further example interfaces of the software application including a communications and subscription/payment interface; and

FIG. 8 illustrates a diagram associated with a further example interface of the software application in the form of an alerts/notification interface.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth to provide a better understanding of the present disclosure. It will be readily apparent, however, that the current disclosure may be practiced without limitation to the specific details. In other instances, some methods and structures have not been described in detail to avoid obscuring the present disclosure.

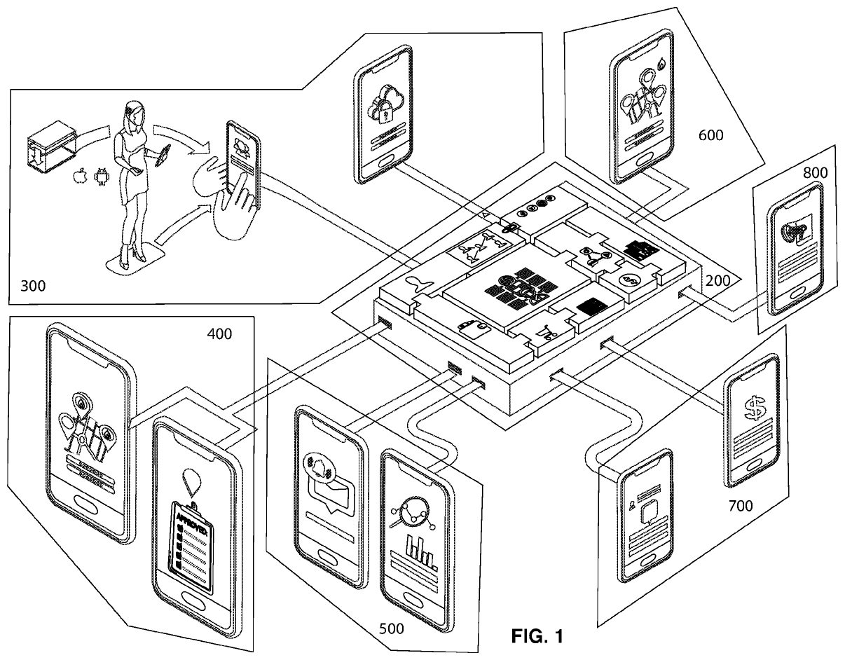

The present invention, according to an embodiment, relates to a system and method for generating emergency alerts including by displaying (170), in response to a user request, geo-fenced zones (70) within, or in proximity to, a geographical area or location of interest (60) to the user (30) (also referred to herein as individual (30)), as depicted in FIG. 1. The display details any zones which are affected by a recorded hazard or potential hazard.

The system and method according to the embodiment(s) described therefore provides a platform that hosts a computer-executable software application (40), wherein the application (40) is accessible by individuals (30) seeking not only information relating to recorded hazards or potential hazards at or near a particular geographical area or location of interest (60), but who are also seeking to engage in one or more activities in the geographical area or location requiring an activity permit (80). The platform enables the generation of the abovementioned display (170), and the automatic issuing of an electronic permit (80) to a device (50) associated with the individual (30) for any permitted activities, the permit (80) authorizing the individual (30) to engage in the activities in the particular geographical area or location (60).

The platform is provided by a central server (20) which maintains one or more processors and/or databases for performing functions, including receiving a request from a user device (50) for information relating to a particular geographical area or location of interest (60), retrieving information related to recorded hazards or potential hazards from a database containing such information, and based upon the existence of a recorded hazard or potential hazard at the particular geographical area or location of interest (60), causing the device (50) to display the geo-fenced zones (70). The display details any zones which are affected and/or may be affected by the recorded hazard or the potential hazard. Where there are no recorded hazards or potential hazards at or near the particular geographical area or location of interest (60), the device (50) is caused to prompt the individual (30) to select one or more activities that will be occurring, or is likely to occur, in the geographical area or location in which the individual (30) is, or likely to be, engaged.

The server (20) is further configured to retrieve information related to prohibitions or restrictions that exist at the particular area or location (60), and information pertaining to activities requiring a permit as a result of the recorded prohibitions or restrictions. Based upon the activities nominated by the individual (30), an electronic permit (80) may be automatically issued to the individual's device (50) in respect of any permitted activities.

The person in the relevant field of technology will appreciate that the platform provides a solution to existing problems associated with individuals being unaware, or incapable of determining in a timely manner, the existence of prohibitions or restrictions regarding activities or any additional emergencies that may be active or expected in a particular area or location of interest (60). The platform further addresses various of the emergency and activity management issues faced by authorities in the case of an actual or potential hazard recorded at a particular area or location. Practical and useful results arise from the platform's ability to quickly and efficiently search, locate and retrieve information of particular relevance to individuals confronted with some of the abovementioned problems.

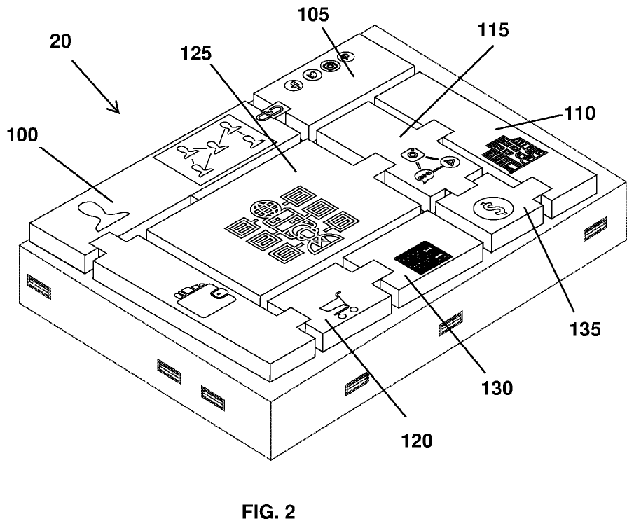

FIG. 1 is divided into segments which are further expanded in subsequent FIGS. 2-8. In particular, segment 200 of FIG. 1 shows the server component (20) with which a software application (40) operating on data communication devices (50) of individuals (30) is configured to communicate. It will be apparent to the person skilled in the relevant field of technology that the software application (40) may be a mobile application or web application, and similarly, the data communication devices (50) utilised by the individuals (30) may be portable devices or fixed location computing devices. Examples of portable devices include laptops, mobile phones and tablets, and examples of fixed location computing devices include workstations and personal computers. The server component (20) is additionally detailed in FIG. 2.

The skilled person will further appreciate that the steps described herein may be executed by the devices (50), wherein such operations are facilitated via the software application (40) operating on each device (50). According to another implementation, the server (20) may be programmed to provide all, or most, of the processing functions described herein, where they cannot be provided locally on the user devices (50) or where it may be commercially or technically impractical to implement such arrangements. In other words, the steps described herein as performed by the device (50), or components thereof, may be associated with hardware that is located externally of the device (50) such as the remote central server (20) for example (i.e. in a distributed architecture). Different arrangements are possible in this regard, and alternate variations will be apparent to the person skilled in the relevant field of technology.

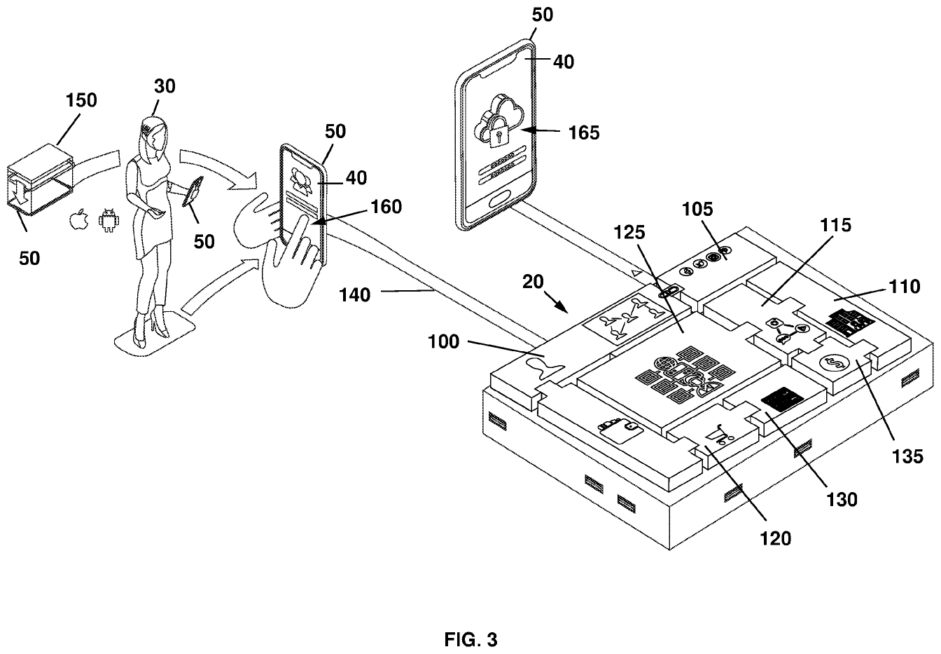

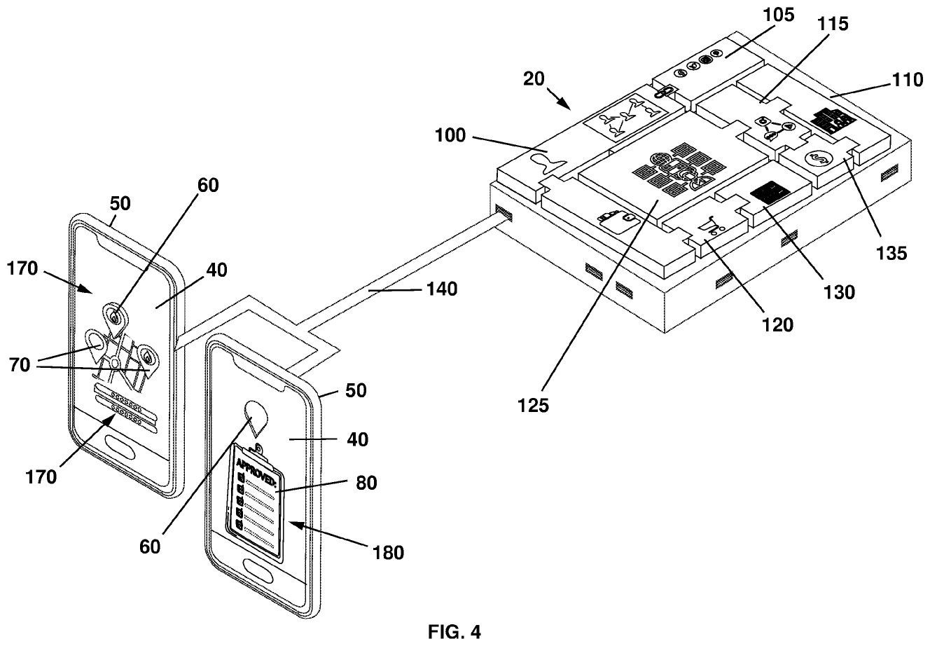

Segment 300 of FIG. 1 shows how the server (20) may be configured for communication with the devices (50) associated with individuals (30), as well as external databases and other sources of information. In one example, after an individual (30) has downloaded and installed the application (40), the server (20) may receive data from the devices (50) for the purpose of establishing a user account and profile, e.g. based upon the entry of details from individuals (30). Data is also retrieved from external databases (not shown) to obtain relevant hazard and permit data, as further detailed in FIG. 3. Segment 400 of FIG. 1 illustrates example interfaces (170) and (180) in which generated hazard results and an electronic activity permit are presented to individuals (30) seeking to visit (and engage in certain activities) in a particular geographical area or location of interest (60), as further detailed in FIG. 4.

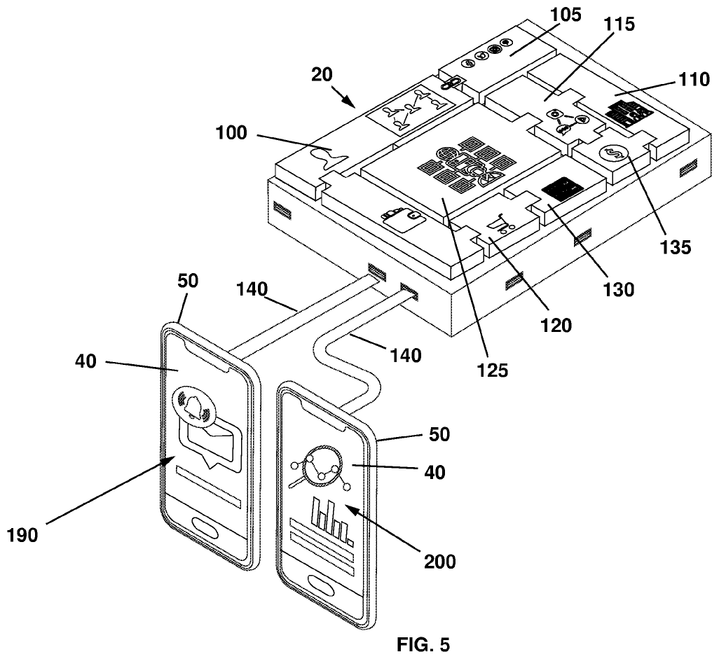

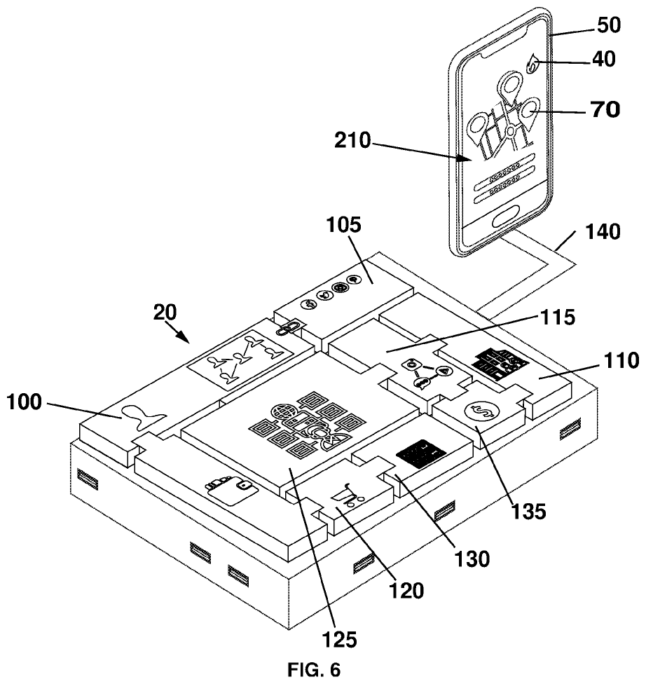

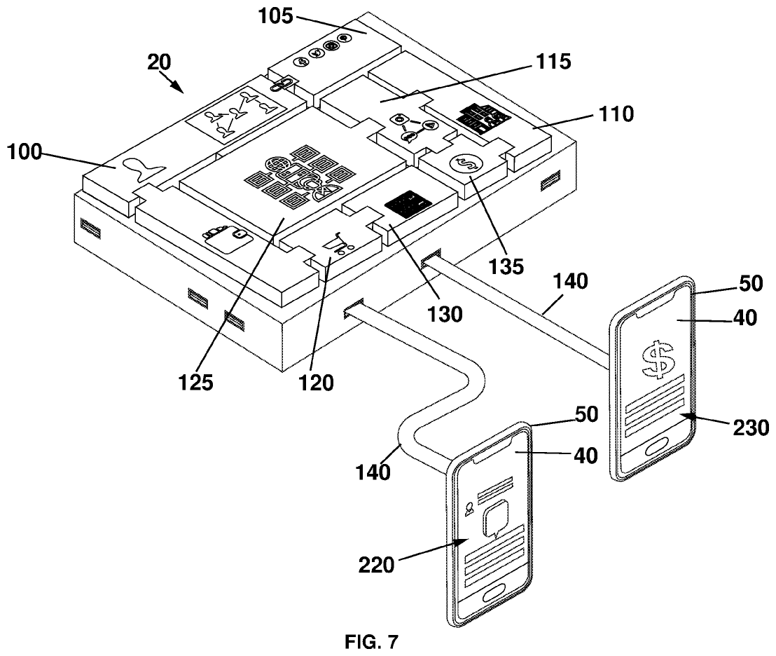

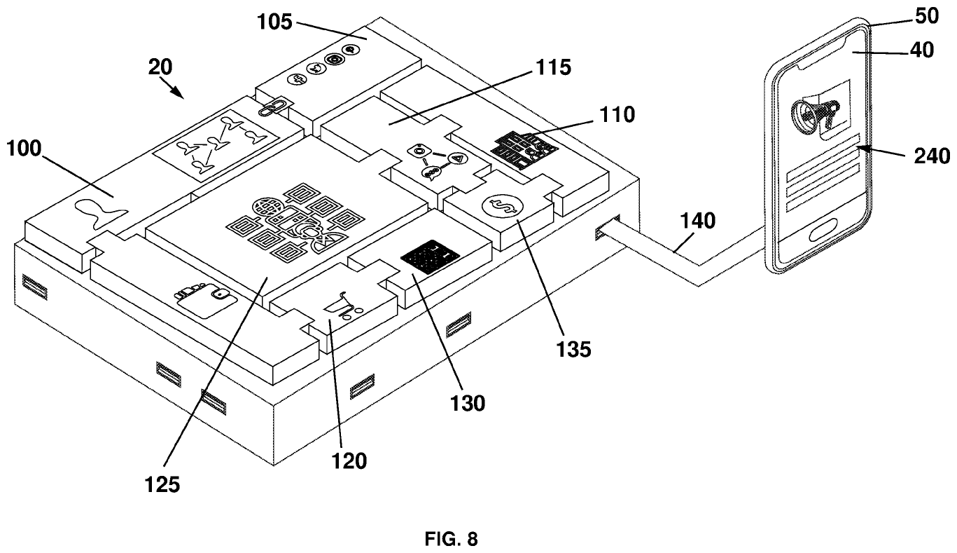

Segment 500 of FIG. 1 illustrates example interfaces (190) and (205) in which hazard alerts may be provided to individuals (30) and other relevant users/authorities, including enabling safety information and checklists to be provided to individuals (30), as further detailed in FIG. 5. Segment 600 of FIG. 1 illustrates an example interface (210) that may be accessed by authorities, property owners and the like to obtain relevant hazard information, as further detailed in FIG. 6. Segment 700 of FIG. 1 illustrates example interfaces (220) and (230) including a communications interface, and a subscription/payment interface, as further detailed in FIG. 7. Finally, Segment 800 of FIG. 1 illustrates an example interface (240) that enables additional alerts and/or notifications to be issued to individuals (30), as further detailed in FIG. 8.

As mentioned above, FIG. 2 shows in greater detail segment 200 of FIG. 1, and in particular, FIG. 2 shows the server component (20) which includes infrastructure upon which the platform of the present invention operates. The infrastructure may be local or cloud-based. The central server (20) may operate one or more computer processors and maintain one or more databases to enable the following functionality and/or storage:
User account register (100) storing details relating to registered users including individuals (30) seeking emergency alert information relating to a particular geographical area or location (60), including information such as name, address and contact details, and similar information relating to other relevant persons or entities such as emergency authorities (police, ambulance, hospitals, etc) whose contact details are important to store and maintain, as well as property owners who may reside adjacent to areas that are prone to hazards and who may prefer to exchange information regarding hazards or potential hazards in their/adjacent areas;
Location database (110) storing details relating to geographical areas/locations (60) and associated geo-fenced zones (70) available for searching by individuals (30). For example, the database (110) may link the particular areas or locations (60) with areas within the same proximity for the purpose of defining a geo-fenced zone (70) around the location that will be displayed to individuals (30). Database (110) may also link registered users with particular locations or areas, including for example linking the closest emergency services (e.g. the nearest police, ambulance, hospital, etc) to each particular location or area (60). Also stored in database (110) may be historical information relating to areas or locations (60) at which hazards have been recorded, areas or locations (60) previously searched by individuals (30), the current location of each registered user, and a record of “favourite” areas of locations of individuals (30);
Hazard or potential hazard database (115) storing details relating to currently recorded hazards or potential hazards in particular geographical areas or locations (60). Whilst this information is generally accessed from an external database, there may be situations where the hazard or potential hazard has not been recorded externally and has been recorded for the first time using the software application (40). Database (115) may also store historically recorded hazard information including in relation to the type, interval, severity, injuries and/or deaths recorded, property damage recorded, etc associated with the hazard;
Activities database (120) storing details relating to currently recorded activities (i.e. activities which are currently being conducted in any one registered area/location), historically recorded activities associated with each area/location or each user, and documentation relating to activities such as safety instruction manuals or checklists for carrying out activities including vacating particular locations in a safe manner;
Data processing functionality (125) for processing user input commands and additional data received, and to generate outputs for display. For example, functionality (125) may utilise one or more information technology techniques for processing requests from individuals (30), retrieve data relating to recorded or potential hazards, and efficiently locate the relevant geo-fenced zones (70) (within, or in proximity to, a particular searched geographical area or location of interest (60)) for display (170) to the individual (30). Further, retrieved prohibition/restriction data pertaining to activities in certain areas/locations, including those requiring a permit, may be processed to efficiently determine whether a proposed activity of the individual (30) requires a permit (80) and if so, automatically issuing a permit (80);
Permit database (130) storing permits (80) which may be stored according to category (e.g. type, activity, geographical area/location, etc) to enable quick and seamless retrieval of same, and further storing permit-related information including in relation to currently issued permits (80), details of individuals (30) to whom permits (80) have been issued, expiry information, and information relating to the particular permitted activity or activities; and
Payment gateway (135) which enables financial transactions between registered users, e.g. payment of a subscription fee to an administrator (not shown) of the platform, etc.

FIG. 2 also depicts that server (20) is configured to enable communication (140) with the devices (50) and, in particular, the software application (40) operating on each device (50). Such communications may occur by use of a data communications network such as the internet or similar network.

FIG. 3 shows in greater detail the various components depicted in segment 300 of FIG. 1 and, in particular, the steps associated with an individual (30) installing (150) the software application (40) on their devices (50), and subsequently accessing a user login and registration interface (160) associated with the application (40). Such access may be granted after the individual (30) has installed the application (40) which may be achieved by downloading the application (40) from an application store. Each individual (30) may create an account (which may include a user profile) using the application (40) and the account/profile information may be stored in the user account database (100).

As previously described, the server (20) will have access to one or more databases or external sources for the purpose of retrieving hazard-related information as well as information relating to activity permits for particular geographical areas/locations. Interface (165) depicted in FIG. 3 demonstrates an example interface of the software application (40) in the process of retrieving such information. The application (40) may have regular software updates to ensure that the external sources from which data is being sourced represents the most up to date and accurate sources of information. It is imperative that information pertaining to emergency situations, particularly situations that are potentially life threatening, is obtained from the most reliable of sources. In this regard, the information or the database(s) from which information is retrieved may also require authentication (eg. the data or database(s) may be required to undergo one or more verification techniques) and this may also be achieved by using interface (165).

FIG. 4 shows in greater detail the various components depicted in segment 400 of FIG. 1 and, in particular, the steps associated with providing the individual (30), through an interface (170), a response to a request received from the individual (30) for information pertaining to any hazards or potential hazards recorded at a particular geographical area or location of interest (60). For example, the individual (30) may be planning a holiday at a particular location, or may be driving towards a particular location, and prefers to understand whether any hazards or risks have been identified and/or recorded for the location(s) of interest (60).

In the embodiment shown in FIG. 4, the individual (30) has specified a particular geographical area or location of interest (60) in their request, hence the generated display (170) shows an interactive map including an indication (60) of the particular geographical area or location (60), as well as geo-fenced zones (70) which are within, or in proximity to, the geographical area or location of interest (60). The zones (70) which are affected by a recorded hazard or potential hazard may be marked (in the example shown, by displaying a fire symbol indicating the presence or risk of a bushfire). In this way, the individual (30) is presented with substantially real-time emergency information relating to a particular area or location for which the individual (30) may have an intention to visit. In circumstances where the individual (30) is already present at the particular area or location (60), the application (40) may be utilized to determine any new emergency risks which have arisen with respect to their current location or adjacent geofenced zones.

Whilst in the embodiment shown in FIG. 4, the recorded hazard or potential hazard relates to a bushfire, it is to be understood that other emergency situations or hazards may be detailed including floods, severe storms, etc.

In circumstances where no hazards or potential hazards are detailed in the interface (170), or where the individual (30) is sufficiently comfortable that there is no or limited risk at their particular geographical area or location (60), the individual (30) may be prompted to select one or more activities in which the individual is, or is likely to be, engaged at the particular geographical area or location of interest (60). Examples of activities may include starting a campfire, going on a hike, swimming etc. As shown in interface (180), where such activities are identified as requiring a permit (as a result of particular prohibitions or restrictions that exist at the particular geographical area or location of interest (60)), an electronic permit (80) may be automatically issued to the individual (30) via the software application (40). The permit (80) will authorise the individual (30) to engage in the one or more activities in the geographical area or location of interest (60).

In addition to checking for the existence of prohibitions or restrictions that exist at the particular geographical area or location of interest (60), additional verification checks may be conducted including in relation to the individuals (30) seeking permits. This will ensure that if any one individual (30) has an existing history of non-compliance with the restrictions or prohibitions, then the individual (30) may be denied access to an electronic permit (80). Additional checks such as police checks may also be conducted.

In another example, a prohibition or restriction that exists at a particular geographical area or location (60) may arise due to the particular area/location being located in a restricted fire zone, where the one or more activities requiring a permit includes lighting a fire. If the individual (30) has previously been recorded as igniting fires in a manner that fails to comply with certain safety standards and/or instructions previously provided to the individual (30), then such non-compliance may affect the individual's ability to obtain future permits.

When individuals (30) are presented with geo-fenced zones (70) within, or in proximity to, the geographical area or location of interest (60), where zones which are affected by the recorded hazard or potential hazard are highlighted (e.g. by application of a unique graphical representation or depiction), the individuals (30) may be further prompted to select a particular zone (60) or (70) in order to access further details regarding the zone and any hazard that is active or predicted for that zone. The details may further include contact details relating to relevant emergency services or links to one or more emergency services including, for example, an interface that enables a live data exchange between the individual (30) and a selected emergency service. Emergency services may include police, ambulance and hospital services, for example.

FIG. 5 shows in greater detail the various components depicted in segment 500 of FIG. 1 and, in particular, additional example interfaces (190) and (200) associated with software application (40). Interface (190) enables individuals (30) to be alerted regarding hazards or potential hazards at a particular geographical area or location of interest (60) in circumstances where the individual (30) has not previously utilised the software application (40) to submit a request for information in respect of the particular area or location. For example, it may be that the individual (30) is merely driving past, or in the vicinity of, a particular area/location in which a hazard has been recorded, and the individual (30) may prefer to be alerted or retrieve information via the software application (40) regarding the nearby hazard.

In another example, the individual (30) may have already travelled to the particular area or location, and may have received a permit (80) authorizing the individual (30) to conduct particular activities at the particular geographical area or location of interest (60). In other words, the alert shown in interface (190) may relate to a hazard or potential hazard which has only recently been recorded and not previously viewed by the individual (30). Such hazard alerts may include additional information including any notifications issued by relevant emergency authorities in respect of the hazard or potential hazard.

The interface (190) may also provide an alert or notification to the individual (30) in circumstances where, for example, a geographical area or location of interest (60) which the individual (30) has previously indicated to be a ‘favourite’ area or location has recorded an actual, or potential, hazard.

Also shown in FIG. 5 is an interface (200) for providing relevant safety instructions to individuals, which may include checklists for use in particular areas or locations, or with respect to dealing with particular hazards or conducting particular activities. In the example of activities, the permit (80) issued to the individual (30) may have recorded against it certain factors such as the particular location to which the permit relates, as well as a category of activity authorized by the permit. For example, in the case of a permit authorizing the individual (30) to ignite a fire, the permit category may be “fire” and the permit may also carry certain sub-categories including the type of fire that is allowed to be ignited (eg. “small campfire”, “picnic fire”, or “hazard reduction burning”). Where a permit is issued to the individual (30) to authorise the individual to conduct such activities, interface (200) may provide a checklist of safety measures in relation to the one or more activities. For example, where the activity is igniting a fire, the checklist may provide safety instructions to the individual (30) for lighting a fire upon (or after) the issuance of the fire permit (80). Similarly, if the individual (30) is already present in a particular area or location (60) and is alerted to a new hazard or potential hazard, the interface (200) may provide the individual (30) with relevant safety instructions to exit the particular area or location. For example, a bushfire may be threatening one or more particular exits, and interface (200) may instruct the individual (30) to utilise an alternative exit which is not affected by the particular hazard including providing an interactive map with directions.

The interface (200) may also provide individuals (30) who have been issued a permit for one or more activities with a checklist for leaving the particular area or location in a suitable condition (eg. a checklist for extinguishing an ignited fire according to minimum safety standards). The individual (30) may be required to submit the completed checklist prior to being granted exit from the particular area or location, whereby such completed checklists may be automatically sent to relevant authorities via the software application (40). In the event checklist details are not received within a pre-defined time period, or are not complete, the system may automatically issue a notification to the relevant authority. In this regard, where it is confirmed that the individual (30) has not submitted or completed the checklist, or has left the particular location in an unsatisfactory condition, a score or rating associated with the individual may be affected (eg. points may be deducted, or score/rating may be reduced). Where the particular point score/rating does not satisfy a pre-defined threshold, the individual (30) may be prevented from undertaking similar activities in the same or other locations/geographical areas in the future.

FIG. 6 shows in greater detail the various components depicted in segment 600 of FIG. 1 and, in particular, an example interface (210) which represents a version of the software application (40) that is accessible by authorities as well as property owners who may also have an interest in monitoring hazards or potential hazards in close proximity to their properties and to exchange information. In this way, a relevant authority may also receive up-to-date information regarding the hazards, including relevant hazardous zones (70), which will facilitate the management of any emergency situations that arise.

The platform may store data relating to recorded hazards which may subsequently be processed for the purpose generating relevant outputs. One such output may include the generation of safety instructions for individuals (eg. instructions for exiting a particular geographical area or location). In the example described earlier, there are multiple possible exits from a particular area or location, and by providing data relating to hazards or potential hazards into the system, the data processing functionality (125) of server (20) may process such data and generate new or updated safety instructions automatically. In this regard, the system may utilise one or more artificial intelligence techniques to generate or update safety instructions, including departure instructions, that will become more relevant and accurate over time as additional data, including outcome data relating to the success or otherwise of previous safety management measures, are received and utilised as input.

Where a permit (eg. a fire permit) has previously been issued to an individual (30) and is current with respect to a particular geographical area or location, the map displayed in interface (210) may also provide authorities with a visual indicator regarding details of the permit and the individual (30) to whom the permit was issued. For example, the display may further include the contact details of the individual (30) to which the fire permit has been issued, which will assist if authorities are required to contact the individual (30) in an emergency situation.

Property owners may utilise the software application (40), and in particular interface (210), to ascertain whether their property or any adjacent properties may be at risk of being exposed to hazards or potential hazards. Furthermore, property owners may be provided with a facility to exchange information that may be useful to all parties in the management of emergency situations that arise. In the example of a fire hazard, useful information from nearby property owners may relate to their water sources and fire breaks, for example. Reminder notifications may be sent to property owners through interface (210) in relation to maintenance of, and access to, their water sources and firebreaks or any other resources associated with the property owner which may assist in any future emergency situations. Similarly, property owners may be provided with information to assist managing any risk to themselves and their properties, including information regarding the preparation of their property in the event of an active fire (or other hazard) in close proximity to their property, the information including, but not limited to, gutter cleaning, rubbish removal, grass cutting, sprinkler activation, etc.

FIG. 7 shows in greater detail the various components depicted in segment 700 of FIG. 1 and, in particular, a communications interface (220) and a subscription/payment interface (230). Interface (220) may enable communications between all relevant parties including, for example, between the individuals (30), emergency authorities, and property owners. In one example, an emergency authority may prefer to contact an individual (30) located in a hazardous area or location. Where contacting the individual through other means may not be possible, communication may be established via the chat facility provided in interface (220). In another example, the individual (30) may require assistance in relation to complying with certain instructional materials or checklists, and therefore interface (220) may be utilised to enable the individual (30) to contact relevant entities responsible for the particular area or location at which the activities are proposed to be conducted.

Of course, the software application (40) may enable communications between registered users and other entities such as hospitals and emergency authorities who may not necessarily be registered with the software application (40).

In addition to the interface (220) providing a chat functionality, the application (40) may also allow communications to be exchanged via email, text message or push notification.

The payment gateway (135) associated with server (20) manages the exchange of funds between users. For example, any user who seeks to register to use the software application (40) may be required to pay a subscription fee to a platform administrator (not shown), and payment gateway (135) and the use of interface (230) shown in FIG. 7 may facilitate such financial transactions.

FIG. 8 shows in greater detail the various components depicted in segment 800 of FIG. 1 and, in particular, a further alerts/notifications interface (240) which may be accessed by individuals (30) as well as any additional registered users such as emergency authority personnel, property owners, etc. Various alerts and notifications beyond those which have been previously described in association with other interfaces may be provided through interface (240). Examples of additional alerts or notifications may include alerts or notifications for notifying users when new activities become available at particular geographical areas or locations of interest (60), any updates with respect to restrictions or prohibitions regarding activities at particular areas or locations or interest, and the like.

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method for generating emergency alerts, the method comprising:
receiving, by one or more processors, a request from a user device for information relating to one or more particular geographical areas or locations of interest;
retrieving, by one or more processors, from a database containing information regarding recorded hazards or potential hazards in a plurality of different geographical regions or locations, information pertaining to any hazards or potential hazards recorded at the one or more particular geographical areas or locations of interest;
based upon the existence of a recorded hazard or potential hazard at the one or more particular geographical areas or locations of interest, and in response to the request, causing the user device to display geo-fenced zones within, or in proximity to, the one or more particular geographical areas or locations of interest detailing any zones which are affected by the recorded hazard or potential hazard; and
based upon there being no recorded hazards or potential hazards at the one or more particular geographical areas or locations of interest:
causing, by one or more processors, the user device to prompt the a user to select one or more activities occurring, or likely to occur, and in which the user is, or likely to be, engaged, in the one or more particular geographical areas or locations of interest;
retrieving, by one or more processors, from a database containing information related to prohibitions or restrictions relevant to the one or more particular geographical area or location of interest, information pertaining to activities requiring a permit as a result of any prohibitions or restrictions; and
based upon the one or more activities requiring a permit, automatically issuing, by one or more processors, an electronic permit to the user device for any permitted activities that authorises the user to engage in the one or more activities in the one or more particular geographical areas or locations of interest.

2. The method of claim 1 further comprising:
storing, by one or more processors, data relating to the activities selected by a plurality of different users in the one or more particular geographical areas or locations of interest, and data relating to permits issued in respect of the activities;
receiving, by one or more processors, a request from an authority responsible for managing emergency situations to access a report regarding the one or more particular geographical locations or areas of interest; and
providing, by one or more processors, in response to the request from the authority responsible for managing emergency situations a report regarding activities recorded and any permits issued in respect of the one or more particular geographical areas or locations of interest.

3. The method according to claim 2, wherein a central server is operable to communicate with the user device in addition to any devices operated by the authority responsible for managing emergency situations, with each device operable to execute a software application that enables communication with the central server.

4. The method of claim 1, wherein the prohibition or restriction that exists at the one or more particular geographical areas or locations of interest arises from the one or more particular geographical areas or locations of interest being in a restricted fire zone, and the one or more activities requiring a permit comprises igniting a fire.

5. (canceled)

6. The method of claim 1, wherein when a hazard or potential hazard is recorded at the one or more particular geographical areas or locations of interest, or associated geo-fenced zone, the method further comprises:
causing, by one or more processors, the user device to alert the user to the hazard or potential hazard comprising providing the user with one or more notifications issued by an authority responsible for managing emergency situations.

7. The method of claim 1, wherein when the one or more particular geographical areas or locations of interest, and geo-fenced zones within or in proximity thereto, are displayed to the user and one or more are affected by the recorded hazard or potential hazard, the method further comprises:
causing, by one or more processors, the user device to prompt the user to select the particular area or location of interest or geo-fenced zone designated on the display of the user device as an area of an actual or potential hazard, to access further details regarding the hazard or potential hazard comprising links to one or more authorities responsible for managing emergency situations and enabling a live data exchange between the authority and the user.

8. The method of claim 1, wherein the electronic permit issued to the user is created based on location and category, such that different permits will issue in respect of different locations and/or different categories of activities comprising activity sub-categories.

9. (canceled)

10. The method of claim 1, wherein issuing an electronic permit to the user device further comprises:
providing, to the user device upon issuance of the electronic permit, or at a particular time thereafter, a checklist of safety measures in relation to the one or more activities.

11. (canceled)

12. The method of claim 8, further comprising:
causing, by one or more processors, the user device to prompt the user to submit a completed checklist; and
receiving, by one or more processors, the completed checklist and automatically transmitting same to a relevant authority responsible for managing emergency situations in the one or more particular geographical areas or locations of interest.

13. The method of claim 12, further comprising:
detecting, by one or more processors, that the completed checklist has not been received within a pre-defined time period of the user vacating the particular geographical area or location of interest; and
automatically transmitting, by one or more processors, a notification regarding the non-completion of the checklist by the user to the relevant authority responsible for managing emergency situations in the particular geographical area or location of interest.

14. The method of claim 13, wherein detecting that the user has vacated the particular geographical area or location of interest is achieved by monitoring a location of the user device using one or more of GPS, Wi-Fi, Cell ID or A-GPS monitoring.

15. The method of claim 1, further comprising:
causing, by one or more processors, devices associated with relevant authorities responsible for managing emergency situations in the one or more particular geographical areas or locations of interest to also display the information pertaining to hazards or potential hazards recorded at the one or more particular geographical areas or locations of interest, and geo-fenced zones within, or in proximity to, the one or more particular geographical areas or locations of interest detailing any zones which are affected by the recorded hazard or potential hazard.

16. The method of claim 15, wherein the information displayed on devices associated with authorities responsible for managing emergency situations further comprises a map and associated information pertaining to permits issued to users in relation to the one or more particular geographical areas or locations of interest displayed on the map.

17. The method of claim 16, wherein the information pertaining to permits comprises one or more of details of the permit, a category or sub-category of the permit, the user to whom the permit was issued, and contact details of the user.

18. The method of claim 1, wherein when a user device is determined to be in proximity to a geographical area or location in which an actual, or potential, hazard has been recorded, the method further comprises:
causing, by one or more processors, the user device to generate one or more alerts or notifications for transmission to the user.

19. The method of claim 1, further comprising providing access to information pertaining to hazards or potential hazards in particular geographical areas or locations to users who are or represent property owners within the particular geographical areas or locations, wherein said access is sufficient to enable property owners to upload information pertaining to their properties for addressing emergency situations that arise in their proximity.

20. The method of claim 19, wherein the information uploaded by property owners comprises information relating to the location and operation of hardware that exists on the property that is configured to prevent or address particular hazards or potential hazards.

21. The method of claim 19, further comprising:
transmitting, by one or more processors, information to the users who are, or represent, property owners regarding the preparation of their property in the event of a hazard on or in close proximity to their property.

22. A system for generating emergency alerts, the system comprising one or more processors that:
receive a request from a user device for information regarding one or more particular geographical areas or locations of interest;
retrieve, from a database containing information related to recorded hazards or potential hazards in a plurality of different geographical regions or locations, information pertaining to any hazards or potential hazards recorded at the one or more particular geographical areas or locations of interest;
based upon the existence of a recorded hazard or potential hazard at the particular geographical area or location of interest, and in response to the user request, cause the user device to display geo-fenced zones within, or in proximity to, the one or more particular geographical areas or locations of interest detailing any zones which are affected by the recorded hazard or potential hazard; and
based upon there being no recorded hazards or potential hazards at the particular geographical area or location of interest:
cause the user device to prompt a user to select one or more activities occurring, or likely to occur, and in which the user is, or likely to be, engaged, in the one or more particular geographical areas or locations of interest;
retrieve, from a database containing information related to prohibitions or restrictions relevant to the one or more particular geographical areas or locations of interest, information pertaining to activities requiring a permit as a result of any prohibitions or restrictions; and
based upon the one or more activities requiring a permit, automatically issue an electronic permit to the user device for any permitted activities that authorises the user to engage in the one or more activities in the particular geographical location or area of interest.

23. A non-transitory computer-readable medium that, when executed on a computer, causes one or more processors of the computer to perform steps to generate emergency alerts, comprising:
receiving a request from a user device for information relating to a one or more particular geographical areas or locations of interest;
retrieving, from a database containing information regarding recorded hazards or potential hazards in a plurality of different geographical regions or locations, information pertaining to any hazards or potential hazards recorded at the one or more particular geographical areas or locations of interest;
based upon the existence of a recorded hazard or potential hazard at the one or more particular geographical areas or locations of interest, and in response to the request, causing the user device to display geo-fenced zones within, or in proximity to, the one or more particular geographical areas or locations of interest detailing any zones which are affected by the recorded hazard or potential hazard; and
based upon there being no recorded hazards or potential hazards at the one or more particular geographical areas or locations of interest:
causing the user device to prompt the user to select one or more activities occurring, or likely to occur, and in which the user is, or likely to be, engaged, in the one or more particular geographical areas or locations of interest;
retrieving, from a database containing information related to prohibitions or restrictions relevant to the one or more particular geographical areas or locations of interest, information pertaining to activities requiring a permit as a result of any prohibitions or restrictions; and
based upon the one or more activities requiring a permit, automatically issuing an electronic permit to the user device for any permitted activities that authorises the user to engage in the one or more activities in the one or more particular geographical locations or areas of interest.
